(19) United States
(12) Patent Application Publication
(10) Pub. No.: US 2024/0378093 A1
(43) Pub. Date: Nov. 14, 2024

(54) DATA PROCESSING METHOD, EXECUTION WORKSTATION, ELECTRONIC DEVICE, AND STORAGE MEDIUM

(71) Applicant: TSINGHUA UNIVERSITY, Beijing (CN)

(72) Inventors: Bowen YU, Beijing (CN); Wenguang CHEN, Beijing (CN)

(73) Assignee: TSINGHUA UNIVERSITY, Beijing (CN)

(21) Appl. No.: 18/576,872

(22) PCT Filed: Jul. 6, 2022
(86) PCT No.: PCT/CN2022/104128

§ 371 Date: Jan. 5, 2024

(30) Foreign Application Priority Data
Jul. 7, 2021 (CN) 202110767689.0

(51) Int. Cl. G06F 9/50

(52) U.S. Cl. CPC G06F 9/5083

(57) ABSTRACT

A data processing method, an execution workstation, an electronic device, and a computer-readable storage medium are provided. The method includes: receiving a task allocated to each processing core of the plurality of processing cores from a management workstation; separately executing the task allocated to each processing core by each processing core of the plurality of processing cores, and generating a task result with a pre-determined data structure after each execution of a task; merging the task result generated by each processing core after each execution into a shared task result stored in an internal memory of the execution workstation, the shared task result and the task result generated by each processing core after each execution having a same data structure; and when a pre-determined condition is satisfied, using the shared task result for conducting reduction with a task result of another execution workstation.

### CROSS-REFERENCE TO RELATED APPLICATION

The present application claims priority of the Chinese Patent Application No. 202110767689.0, filed on Jul. 7, 2021, the disclosure of which is incorporated herein by reference in its entirety as part of the present application.

### TECHNICAL FIELD

Embodiments of the present disclosure relate to a data processing method, an execution workstation, an electronic device and a computer-readable storage medium.

### BACKGROUND

Nowadays is a data age, and data informatization is closely related to our life and work. Due to the sharp increase in the amount of data, the stand-alone processing is difficult, so a big data processing framework is designed for distributed computing. The existing big data processing frameworks include Hadoop, Storm, Samza, Flink, Spark, etc., and Spark is one of the most popular big data processing frameworks today. Spark is a big data processing framework based on in-memory computing, which improves the real-time performance of data processing in the big data environment, and simultaneously provides a good horizontal scalability and a fault-tolerant processing mechanism. Spark introduces the abstraction of a Resilient Distributed Dataset (RDD). RDD is a special collection with the fault-tolerant mechanism, and in the case that part of the dataset is lost, the lost part can be reconstructed according to the data derivation process. Because the RDD can be converted into other RDDs through conversion operations, and all the conversion operations are recorded, so Spark uses a lineage graph to track the dependence relationship between RDDs and recompute the lost part of data through the dependence relationship, rather than recomputing all the data. In the case that the lineage chain is very long or the dependence relationship is too wide, then Spark may be unable to rerun when a failure occurs, and the solution is to set checkpoints for such RDDs. By using a lineage and checkpoint techniques, Spark enables fault tolerance and recovery.

### SUMMARY

At least one embodiment of the present disclosure provides a data processing method for distributed computing executed by an execution workstation. The execution workstation includes a plurality of processing cores, and the method includes: receiving a task allocated to each processing core of the plurality of processing cores from a management workstation; separately executing the allocated task by each processing core of the plurality of processing cores, and generating a task result with a pre-determined data structure after each execution of a task; merging the task result generated by each processing core after each execution into a shared task result stored in an internal memory of the execution workstation, the shared task result and the task result generated by each processing core after each execution having the same data structure; and when a pre-determined condition is satisfied, using the shared task result for conducting reduction with a task result of another execution workstation.

For example, in the data processing method provided by at least one embodiment of the present disclosure, the pre-determined condition is that the shared task result has been merged with a pre-determined number of task results.

For example, in the data processing method provided by at least one embodiment of the present disclosure, the pre-determined condition is to receive an instruction from the management workstation.

For example, in the data processing method provided by at least one embodiment of the present disclosure, the method further includes sending a state of each task being completed to the management workstation; and the instruction is an instruction issued by the management workstation to determine that tasks of a current task group have been completed according to the state of each task.

For example, in the data processing method provided by at least one embodiment of the present disclosure, merging the task result generated by each processing core after each execution into a shared task result stored in an internal memory of the execution workstation includes: generating a shared task result with the pre-determined data structure and an initial value of 0 in the internal memory; and after a processing core completes a task and generates a task result, merging the task result that is generated with a shared task result stored currently, and using a merged result to update the shared task result.

For example, in the data processing method provided by at least one embodiment of the present disclosure, merging the task result generated by each processing core after each execution into a shared task result stored in an internal memory of the execution workstation includes: storing a task result first generated when the plurality of processing cores processes a task of a current task group as an initial shared task result; and after a processing core completes a task and generates a task result, merging the task result that is generated with a shared task result stored currently, and using a merged result to update the shared task result.

For example, in the data processing method provided by at least one embodiment of the present disclosure, using the shared task result for conducting reduction with a task result of another execution workstation includes: serializing the shared task result and sending the serialized shared task result to the another execution workstation or the management workstation; or receiving a task result from the another execution workstations and performing reduction on the task result and the shared task result.

For example, in the data processing method provided by at least one embodiment of the present disclosure, when the pre-determined condition is satisfied, the shared task result is stored into a non-volatile storage apparatus.

At least one embodiment of the present disclosure provides an execution workstation for distributed computing, and the execution workstation includes a receiving module, a plurality of processing cores, a merging module, an internal memory and a result processing module. The receiving module is configured to receive a task allocated to each processing core of the plurality of processing cores from a management workstation; each processing core of the plurality of processing cores is configured to separately execute the allocated task, and generate a task result with a pre-determined data structure each time after each execution of a task; the merging module is configured to merge the task result generated by each processing core after each execution into a shared task result stored in an internal memory of the execution workstation, and the shared task result and the task result generated by each processing core after each execution have the same data structure; and the result processing module is configured to use the shared task result for conducting reduction with a task result of another execution workstations when a pre-determined condition is satisfied.

At least one embodiment of the present disclosure provides an electronic device, including a processor and a memory. The memory stores one or more computer program instructions, the one or more computer program instructions are stored in the memory, and upon being executed by the processor, implement the data processing method provided by any embodiment of the present disclosure.

At least one embodiment of the present disclosure provides a computer-readable storage medium, which is used for storing non-transitory computer-readable instructions, and the data processing method provided by any embodiment of the present disclosure are implemented when the non-transitory computer-readable instructions are executed by a computer.

According to the data processing method, the execution workstation, the electronic device and the computer-readable storage medium provided by the embodiments of the present disclosure, the data storage, processing and communication overhead can be reduced, and the data processing performance can be improved.

### BRIEF DESCRIPTION OF DRAWINGS

To more clearly illustrate the embodiments of the present disclosure, the drawings required to be used for the embodiments are briefly described in the following. It is obvious that the drawings described below are only some embodiments of the present disclosure and are not a limitation of the present disclosure.

FIG. 1 illustrates a system architecture applied to a data processing method provided by at least one embodiment of the present disclosure;

FIG. 2 illustrates a flowchart of a data processing method provided by at least one embodiment of the present disclosure;

FIG. 3 illustrates a method flowchart of step S203 in FIG. 2 provided by at least one embodiment of the present disclosure;

FIG. 4 illustrates another method flowchart of step S203 in FIG. 2 provided by at least one embodiment of the present disclosure;

FIG. 5 illustrates a schematic block diagram of an execution workstation for distributed computing provided by at least one embodiment of the present disclosure;

FIG. 6 illustrates a schematic block diagram of an electronic device provided by at least one embodiment of the present disclosure;

FIG. 7 illustrates a schematic block diagram of another electronic device provided by at least one embodiment of the present disclosure; and

FIG. 8 illustrates a schematic diagram of a computer-readable storage medium provided by at least one embodiment of the present disclosure.

### DETAILED DESCRIPTION

In order to make objects, technical details and advantages of the embodiments of the present disclosure apparent, the technical solutions of the embodiments are described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by those of ordinary skill in the art to which the present disclosure belongs. The terms “first”, “second”, and the like., which are used in the description and the claims of the present disclosure, are not intended to indicate any sequence, amount or importance, but used to distinguish various components. Similarly, the terms “a”, “an”, “the”, or the like are not intended to indicate a limitation of quantity, but indicate that there is at least one. The terms, such as “comprise/comprising”, “include/including”, or the like are intended to specify that the elements or the objects stated before these terms encompass the elements or the objects and equivalents thereof listed after these terms, but not preclude other elements or objects. The terms, such as “connect/connecting/connected”, “couple/coupling/coupled”, or the like, are not limited to a physical connection or mechanical connection, but may include an electrical connection/coupling, directly or indirectly. The terms, “on”, “under”, “left”, “right”, or the like are only used to indicate relative position relationship, and when the position of the object which is described is changed, the relative position relationship may be changed accordingly.

Taking a big data processing framework Spark as an example, Spark allows a single executor to use a plurality of CPU cores in the resource model of Spark. Therefore, a plurality of tasks are scheduled to the same executor in the same stage. Under the existing Spark execution model, after completing each task, each CPU core of the executor serializes the results into byte arrays, stores the results on a hard disk, and sends the results to a driver. In this case, the executor incurs a large storage, processing, and communication overhead, and the inventor in particular finds that the serialization process incurs a significant processing overhead. Therefore, reducing the storage, processing, and communication overhead to obtain a better performance is important.

At least one embodiment of the present disclosure provides a data processing method, an execution workstation, an electronic device and a computer-readable storage medium for distributed computing. The data processing method includes: receiving a task allocated to each processing core off the plurality of processing cores from a management workstation; separately executing the allocated task by each processing core of the plurality of processing cores, and generating a task result with a pre-determined data structure after each execution of a task; merging the task result generated by each processing core after each execution into a shared task result stored in an internal memory of the execution workstation, the shared task result and the task result generated by each processing core after each execution having the same data structure; and when a pre-determined condition is satisfied, using the shared task result for conducting reduction with a task result of another execution workstations.

The data processing method of this embodiment can merge the task results in the same execution workstation in the present execution workstation before being reduced with the task results in other execution workstations, so as to reduce the storage, processing, and communication overhead, and thereby implementing a better performance.

It should be noted that the big data processing framework according to the embodiments of the present disclosure includes but is not limited to Spark. The data processing methods provided by at least one embodiment of the present disclosure may further be suitable for other big data processing frameworks.

FIG. 1 illustrates a system architecture 100 applied to a data processing method provided by at least one embodiment of the present disclosure.

As illustrated in FIG. 1, the system architecture 100 may include a management workstation 101 and an execution workstation 102, and the execution workstation includes a plurality of processing cores 103 and an internal memory 104. The execution workstation 102 is a computation device for performing a task processing in a distributed computing system, for example, the execution workstation 102 can run an executor in the Spark architecture. The management workstation 101 is a computation device responsible for managing each execution workstation 102 in the distributed computing system, for example, the management workstation 101 can run a driver in the Spark architecture, and the management workstation 101 can coordinate, schedule, and monitor the task of each execution workstation. The task result of the workstation 102 can eventually be summarized into the management workstation 101.

The plurality of processing cores 103 can be configured in an execution workstation 102, and the plurality of processing cores 103 in the same execution workstation 102 share the internal memory 104, and the internal memory 104 is used for storing the shared task result. The internal memory 104, also known as a memory, is a memory that scratches programs and data when a computation device is running, and the internal memory 104 may be any form of a volatile memory, such as a random access memory (RAM), a cache, etc. Each of the plurality of processing cores 103 may send a message to the management workstation 101 to request for allocating a task, and the management workstation 101 responds to the request by allocating the task to the processing core 103. Alternatively, the management workstation 101 may also actively allocate tasks to the processing core 103. Each of the plurality of processing cores 103 receives the allocated task from the management workstation 101 and executes. Each of the plurality processing cores 103 generates a task result after each execution of a task. The task result generated by each of the plurality of processing cores 103 after the task is executed is merged into the shared task result stored in the internal memory 104 in the execution workstation 102.

The management workstation 101 may interact with the execution workstation 102 through a communication network, and the execution workstation 102 may interact with other execution workstations 102 through the communication network to receive or send a message. A communication network is used to provide a medium for a communication link between the management workstation 101 and the plurality of processing cores 103, and between the plurality of execution workstations 102. The communication network may include a variety of connection types, such as wired or wireless communication links, specifically such as WIFI, 3G, 4G, 5G, fiber optic cables and the like.

The management workstation 101 is responsible for central coordination, dispatching processing cores 103 in each execution workstation 102, and monitoring the execution state of tasks in each of processing cores 103. Each of the plurality of processing cores 103 executes a task and reports the execution state and progress to the management workstation 101, so that the management workstation 101 grasps the execution state of each task, so as to restart the task when the task fails.

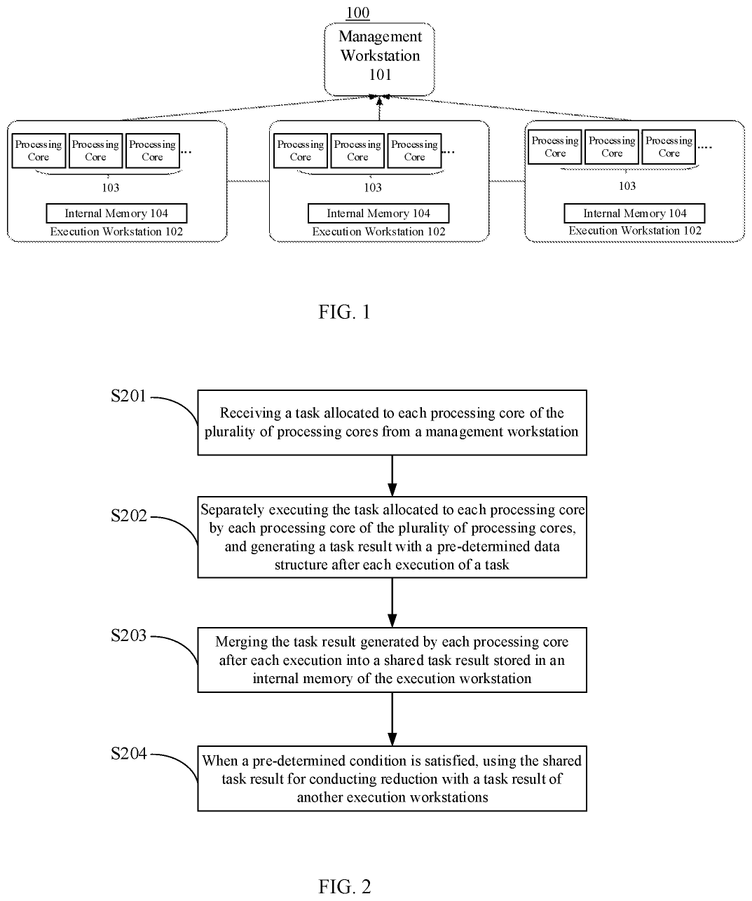

FIG. 2 illustrates a flowchart of a data processing method for distributed computing that can be executed by an execution workstation provided by at least one embodiment of the present disclosure. The execution workstation includes the plurality of processing cores.

As illustrated in FIG. 2, the data processing method includes step S201 to step S204.

Step S201: receiving a task allocated to each processing core of the plurality of processing cores from a management workstation.

Step S202: separately executing the allocated task by each processing core of the plurality of processing cores, and generating a task result with a pre-determined data structure after each execution of a task.

Step S203: merging the task result generated by each processing core after each execution into a shared task result stored in an internal memory of the execution workstation.

Step S204: when a pre-determined condition is satisfied, using the shared task result for conducting reduction with a task result of another execution workstations.

For the step S201, the management workstation may be, for example, a driver, and the management workstation may play a central coordinating role in scheduling tasks, monitoring task progress and so on for each of the plurality of processing cores.

For example, in the system architecture illustrated in FIG. 1, the processing core 101 can send an acquisition request to the management workstation 102 for acquiring a task, and receive a task from the management workstation 102 after the management workstation 102 responds to the acquisition request so as to allocate a task to the processing core 101.

For the step S202, each processing core generates a task result after completing an execution of a task, and the task result has a pre-determined data structure. The data structure can be pre-determined depending on a specific application, for example, the data structure may be an array, or may be other data structures defined by a user.

For the step S203, the execution workstation includes the plurality of processing cores and an internal memory. The internal memory stores the value known as a shared task result, and the shared task result is shared by the plurality of processing cores in the same execution workstation, that is, the plurality of processing cores can access and update the shared task result. The shared task result and the task result generated by the processing core after each execution have the same data structure. Merging refers to the process of merging two or more data into one, for example, two or more data can be performed a summation operation. In the embodiments of the present disclosure, merging the task result generated each time each processing core executes a task into a shared task result represents that the two task results are merged into one task result, and the result is used to update the current shared task result.

For example, firstly an initial shared task result with the pre-determined data structure described above can be generated in the internal memory, the initial shared task result is initialized to 0, and then, after any one processing core in the plurality of processing cores has executed a task, the obtained task result is merged with the current shared task result, and the merged result is used to update the current shared task result. That is, the shared task result is updated after each processing core has processed a task, so that the shared task result carries the information of a plurality of task results, but the amount of the stored data is greatly reduced.

As another example, the task result that is generated for the first time when the plurality of processing cores process tasks in the current task group is stored into the internal memory as the initial shared task result. The task result generated by the subsequent execution of the plurality of processing cores is merged with the shared task result and the shared task result is updated, that is, the task result obtained by any one of the plurality of processing cores after executing a task is merged with the current shared task result, and the merged result is used to update the current shared task result. In the embodiments of the present disclosure, the current task group represents the task group to which the task currently being processed belongs, and the task results in the same task group are emerged. The management executor can divide the interrelated tasks into a task group, and after a task group has been processed, a final result that emerges all the task results is obtained.

For the step S204, when a pre-determined condition is satisfied, the execution workstation obtains the current final shared task result, and the shared task result emerges the plurality of task results, e.g., carries the information of the plurality of task results. In the embodiments of the present disclosure, the final shared task result can be used to be further reduced with a task result of another execution workstation. “Reduction” represents the process of emerging a plurality of data stored by distribution into a single data.

A pre-determined condition may be any condition pre-determined to stop the local emerge in the execution workstation, for example, the pre-determined condition may be that the shared task result has emerged a pre-determined number of task results, or the pre-determined condition may be receiving an instruction from the management workstation.

In some embodiments of the present disclosure, the instruction refers to an instruction issued by the management workstation to determine that the tasks of a current task group have been completed according to a state of each task. For example, the management workstation can monitor the execution state of tasks in each processing core, and each processing core sends the execution state of each task to the management workstation, and in response to the execution state of the task of each processing core, whether all the tasks in the task group have been completed can be determined. When the management workstation determines that all the tasks in the current task group have been completed, the management workstation can send an instruction to the execution workstation. In response to the instruction from the management workstation, the execution workstation uses the current shared task result in the internal memory as the current final shared task result, and no longer updates the shared task result with the task result of the subsequent execution.

Another example is that the management workstation presets the number of task results that each execution workstation should emerge. For each execution workstation, after emerging a pre-determined number of task results, then the current shared task result in internal memory is served as the current final shared task result.

In some embodiments of the present disclosure, using the shared task result for conducting reduction with the task result of another execution workstation, includes: serializing the shared task result and sending the serialized shared task result to the another execution workstation or the management workstation for a further reduction on the another execution workstation or the management workstation; or receiving the task result from the another execution workstation and performing reduction on the task result and the shared task result.

For example, the shared task result of the plurality of execution workstations can be further performed reduction and then be sent to the management workstation. Specifically, for each execution workstation, the shared task results in the internal memory can be serialized and be sent to the another execution workstation for reduction, or the shared task result can be received from the another execution workstation and be performed reduction. After performing reduction on the shared task result in each of the plurality of execution workstations, the result after the further reduction is serialized and sent to the management workstation.

In addition, in the data processing method provided by at least one embodiment of the present disclosure, when the pre-determined condition is satisfied, the execution workstation may also store the shared task result in a non-volatile storage apparatus. Thus, when a failure occurs in an execution workstation, such as a process error, the shared task result can be obtained from the non-volatile storage apparatus, so as to implement a better fault tolerance. The non-volatile storage apparatus may be any form of non-volatile storage apparatuses, such as a magnetic hard drive, a solid-state drive, and the like.

According to at least one embodiment of the present disclosure, in the case where the execution of a task of an execution workstation fails, the execution workstation may clear the current shared task result, and recalculate the task of the current working group and regenerate the shared task result. In addition, when the management workstation detects a task execution failure on an execution workstation, all the tasks of the current task group executed by the execution workstation may be also reallocated. Therefore, the embodiments of the present disclosure still support the lineage fault tolerance.

In summary, according to the data processing method of the embodiments of the present disclosure, after each processing core has completed a task, it is not required to independently store a task result, serialize the processing result and send the processing result, so as to save the storage, processing and communication overhead, and improve the system performance.

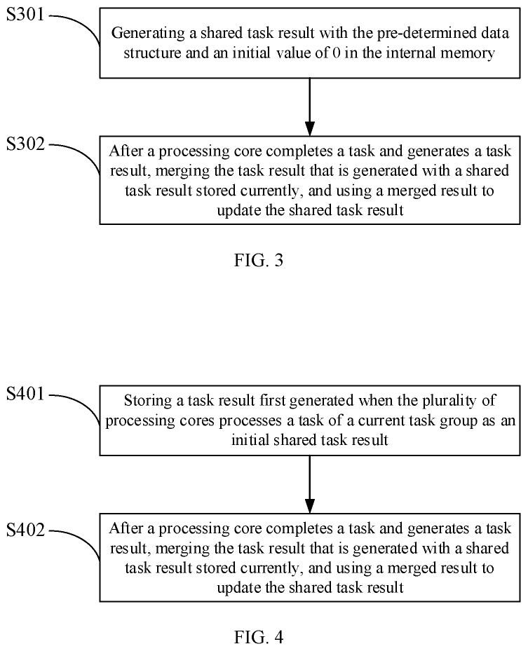

FIG. 3 illustrates a method flowchart of step S203 in FIG. 2 provided by at least one embodiment of the present disclosure.

As illustrated in FIG. 3, the method may include step S301 to step S302.

Step S301: generating a shared task result with the pre-determined data structure and an initial value of 0 in the internal memory.

Step S302: after a processing core completes a task and generates a task result, merging the task result that is generated with a shared task result stored currently, and using a merged result to update the shared task result.

FIG. 4 illustrates another method flowchart of step S203 in FIG. 2 provided by at least one embodiment of the present disclosure.

As illustrated in FIG. 4, the method may include step S401 to step S402.

Step S401: storing a task result first generated when the plurality of processing cores processes a task of a current task group as an initial shared task result.

Step S402: after a processing core completes a task and generates a task result, merging the task result that is generated with a shared task result stored currently, and using a merged result to update the shared task result.

The method of initializing a shared task result described in FIG. 3 and FIG. 4 has been illustrated above and will not be repeated here.

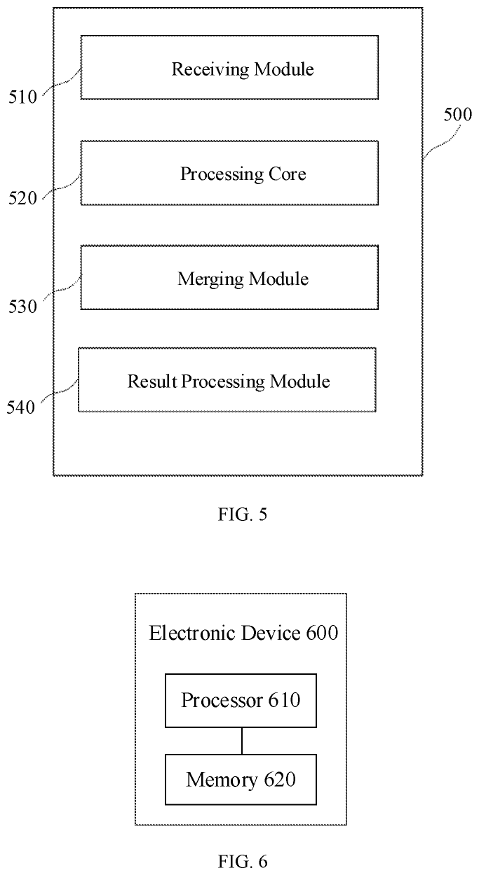

FIG. 5 illustrates a schematic block diagram of an execution workstation 500 for distributed computing provided by at least one embodiment of the present disclosure.

As illustrated in FIG. 5, the execution workstation 500 includes a receiving module 510, a plurality of processing cores 520, a merging module 530 and a result processing module 540.

The receiving module 510 is configured to receive a task allocated to each processing core of the plurality of processing cores from a management workstation.

The receiving module 510, for example, can execute the step S201 described in FIG. 2.

Each processing core of the plurality of processing cores 520 is configured to separately execute the allocated task, and generate a task result with a pre-determined data structure after each execution of a task.

Each processing core in the plurality of processing cores 520, for example, can execute the step S202 described in FIG. 2.

The merge module 530 is configured to merge the task result generated by each processing core after each execution into a shared task result stored in an internal memory of the execution workstation, and the shared task result and the task result generated by each processing core after each execution have a same data structure.

The merge module 530, for example, can execute the step S203 described in FIG. 2.

The result processing module 540 is configured to use the shared task result for conducting reduction with a task result of another execution workstation when a pre-determined condition is satisfied.

The result processing module 540, for example, can executed the step S204 described in FIG. 2.

For example, the receiving module 510, the plurality of processing cores 520, the merging module 530 and the result processing module 540 may be implemented as hardware, software, firmware, and any feasible combination thereof. For example, the receiving module 510, the plurality of processing cores 520, the merging module 530 and the result processing module 540 may be dedicated or general-purpose circuits, chips or apparatuses, etc., and may also be a combination of processors and memory. With regard to the specific implementation form of various above modules, the embodiments of the present disclosure are not limited herein.

It should be noted that in the embodiments of the present disclosure, each module of the execution workstation 500 for distributed computing corresponds to each step of the above data processing method. The specific functions of the execution workstation 500 for distributed computing may refer to the relevant description of the data processing method, which is not repeated herein. The components and structures of the execution workstation 500 for distributed computing illustrated in FIG. 5 are only exemplary and are non-limiting. The execution workstation 500 for distributed computing may further include other components and structures as required.

At least one embodiment of the present disclosure further provides an electronic device, which includes a processor and a memory. The memory includes one or more computer program modules. The one or more computer program modules are stored in the memory and configured to be executed by the processor, and the one or more computer program modules include instructions for implementing the data processing method mentioned above. The electronic device can merge the task results in the same execution workstation in the present execution workstation before being merged with the task result in another execution workstation, so as to reduce the storage, processing and communication overhead, and thereby implementing a better performance.

FIG. 6 is a schematic block diagram of an electronic device provided by some embodiments of the present disclosure. As illustrated in FIG. 6, the electronic device 600 includes a processor 610 and a memory 620. The memory 620 is used to store non-transitory computer-readable instructions (e.g., one or more computer program modules). The processor 610 is used to run the non-transitory computer-readable instructions, and when the non-transitory computer-readable instructions are run by the processor 610, one or more steps of the data processing method described above are executed. The memory 620 and processor 610 can be interconnected by a bus system and/or other form of connection mechanism (not illustrated).

For example, the processor 610 may be a central processing unit (CPU), a graphics processing unit (GPU), or other processing units with the data processing capability and/or the program execution capability. For example, the central processing unit (CPU) may be an X86 or ARM architecture, or the like. The Processor 610 may be a general-purpose processor or a dedicated processor that can control other components in the electronic device 600 to executed the desired functions.

For example, the memory 620 may include any combination of one or more computer program products. The computer program product may include various computer-readable storage media, such as a volatile memory and/or non-volatile memory. The volatile memory may include, for example, a random access memory (RAM) and/or cache. The non-volatile memory may include, for example, a read-only memory (ROM), hard disks, an erasable programmable read-only memory (EPROM), a portable compact disk read-only memory (CD-ROM), a USB memory, a flash memory, and the like. One or more computer program modules may be stored on a computer-readable storage medium, and the processor 610 may execute one or more computer program modules to implement various functions of the electronic device 600. The computer-readable storage medium may further store various application programs, various data, various data used and/or generated by applications, and the like.

It should be noted that in the embodiments of the present disclosure, the specific functions and technical effects of the electronic device 600 can refer to the description of the data processing method mentioned above, which is not repeated herein.

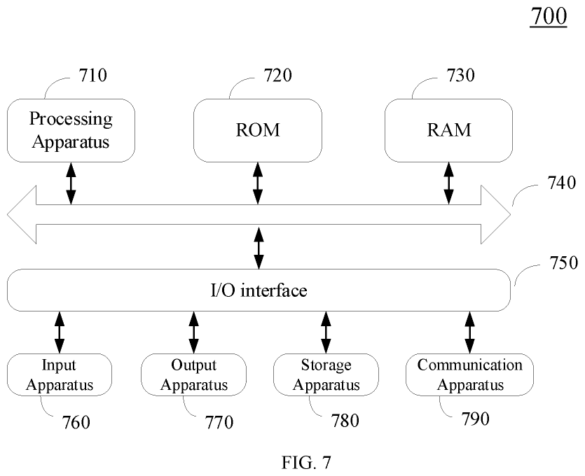

FIG. 7 is a schematic block diagram of another electronic device provided by some embodiments of the present disclosure. The electronic device 700, for example, is suitable for implementing the data processing method provided by the embodiments of the present disclosure. The electronic device 700 may be a terminal device and the like. It should be noted that the electronic device 700 illustrated in FIG. 7 is only an example and does not bring any limitation on the functions and usage scope of the embodiments of the present disclosure.

As illustrated in FIG. 7, the electronic device 700 may include a processing apparatus 710 (e.g., a central processing unit, a graphics processing unit, etc.), which can execute various appropriate actions and processing according to a program stored in a read- only memory (ROM) 720 or a program loaded from the storage device 780 into a random access memory (RAM) 730. The RAM 730 further stores various programs and data that are required by the operation of the electronic device 700. The processing apparatus 710, ROM 720 and RAM 730 are connected to each other via bus 740. The input/output (I/O) interface 750 is also connected to the bus 740.

Generally, the following apparatuses can be connected to the I/O interface 750: including an input apparatus 760 such as a touch screen, a touchpad, a keyboard, a mouse, a camera, a microphone, an accelerometer, a gyroscope, and the like; including an output apparatus 770 such as a liquid crystal display (LCD), a speaker, a vibrator, and the like; including a storage apparatus 780 such as a tape, a hard disk, and the like; and including a communication apparatus 790. The communication apparatus 790 may allow the electronic device 700 to communicate wirelessly or wired with other electronic devices so as to exchange data. Although FIG. 7 illustrates the electronic device 700 with various apparatuses, it should be understood that all of the apparatuses illustrated are not required to be implemented or had, and the electronic device 700 may alternatively implement or have more or fewer apparatuses.

For example, according to the embodiments of the present disclosure, the data processing method mentioned above may be implemented as a computer software program. For example, the embodiment of the present disclosure includes a computer program product. The computer program product includes a computer program carried on a non-transitory computer-readable medium. The computer program includes a program code for implementing the data processing method mentioned above. In such an embodiment, the computer program can be downloaded and installed from a network through a communication apparatus 790, or installed from a storage apparatus 780, or installed from a ROM 720. When the computer program is executed by the processing apparatus 710, the functions defined in the data processing method provided by the embodiments of the present disclosure can be implemented.

At least one embodiment of the present disclosure further provides a computer-readable storage medium. The computer-readable storage medium is used for storing non-transitory computer-readable instructions. When the non-transitory computer-readable instructions are executed by a computer, the data processing method mentioned above can be implemented. The computer-readable storage medium can be utilized to merge the task results in the same execution workstation in the present execution workstation before being reduced with the task result in another execution workstation, so as to reduce the storage, processing and communication overhead.

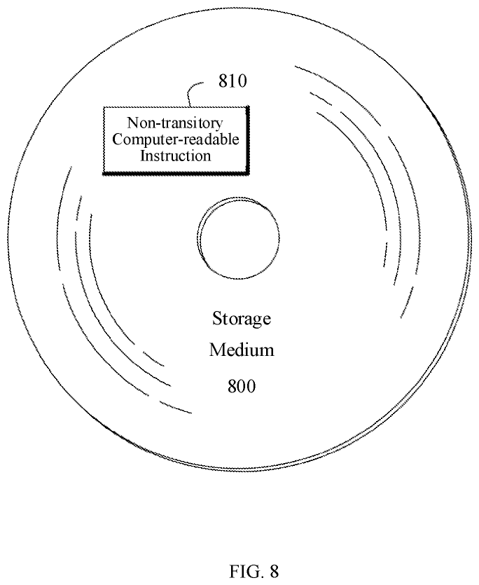

FIG. 8 is a schematic diagram of a storage medium provided by some embodiments of the present disclosure. As illustrated in FIG. 8, the storage medium 800 is used to store non-transitory computer-readable instructions 810. For example, when the non-transitory computer-readable instructions 810 are executed by a computer, one or more steps of the data processing method mentioned above can be executed.

For example, the storage medium 800 can be applied to the electronic device 800 mentioned above. For example, the storage medium 800 may be the memory 620 in the electronic device 600 illustrated in FIG. 6. For example, the related description of the storage medium 800 may refer to the corresponding description of the memory 620 in the electronic device 600 illustrated in FIG. 6, which is not repeated here.

It should be noted that the drawings of the embodiments of the present disclosure only relate to the structures to which the embodiments of the present disclosure relate, and other structures may refer to general designs. Without conflict, the embodiments of the present disclosure and the characteristics in the embodiments may be combined with each other to obtain a new embodiment.

The above description is only the specific embodiments of the present disclosure, but the protection scope of the present disclosure is not limited to the description, and the protection scope of the present disclosure is determined by the appended claims.

1. A data processing method for distributed computing executed by an execution workstation, wherein the execution workstation comprises a plurality of processing cores, and the method comprises:
receiving a task allocated to each processing core of the plurality of processing cores from a management workstation;
separately executing the task allocated to each processing core by each processing core of the plurality of processing cores, and generating a task result with a pre-determined data structure after each execution of a task;
merging the task result generated by each processing core after each execution into a shared task result stored in an internal memory of the execution workstation, the shared task result and the task result generated by each processing core after each execution having a same data structure; and
when a pre-determined condition is satisfied, using the shared task result for conducting reduction with a task result of another execution workstation.

2. The data processing method of claim 1, wherein the pre-determined condition is that the shared task result has been merged with a pre-determined number of task results.

3. The data processing method of claim 1, wherein the pre-determined condition is receiving an instruction from the management workstation.

4. The data processing method of claim 1, wherein the method further comprises sending a state of each task being completed to the management workstation; and
the instruction is an instruction issued by the management workstation to determine that tasks of a current task group have been completed according to the state of each task.

5. The data processing method of claim 1, wherein the merging the task result generated by each processing core after each execution into a shared task result stored in an internal memory of the execution workstation comprises:
generating a shared task result with the pre-determined data structure and an initial value of 0 in the internal memory; and
after a processing core completes a task and generates a task result, merging the task result with a shared task result stored currently to obtain a merged result, and using the merged result to update the shared task result.

6. The data processing method of claim 1, wherein the merging the task result generated by each processing core after each execution into a shared task result stored in an internal memory of the execution workstation comprises:
storing a task result first generated when the plurality of processing cores processes a task of a current task group as an initial shared task result; and
after a processing core completes a task and generates a task result, merging the task result with a shared task result stored currently to obtain a merged result, and using the merged result to update the shared task result.

7. The data processing method of claim 1, wherein the using the shared task result for conducting reduction with a task result of another execution workstation comprises:
serializing the shared task result to obtain a serialized shared task and sending the serialized shared task result to the another execution workstation or the management workstation; or
receiving a task result from the another execution workstation and performing reduction on the task result and the shared task result.

8. The data processing method of claim 1, further comprising:
when the pre-determined condition is satisfied, storing the shared task result into a non-volatile storage apparatus.

9. An execution workstation for distributed computing, the execution workstation comprising a receiving module, a plurality of processing cores, a merging module, an internal memory and a result processing module, wherein:
the receiving module is configured to receive a task allocated to each processing core of the plurality of processing cores from a management workstation;
each processing core of the plurality of processing cores is configured to separately execute the task allocated to each processing core, and generate a task result with a pre-determined data structure each time after each execution of a task;
the merging module is configured to merge the task result generated by each processing core after each execution into a shared task result stored in an internal memory of the execution workstation, and the shared task result and the task result generated by each processing core after each execution have a same data structure; and
the result processing module is configured to use the shared task result for conducting reduction with a task result of another execution workstation when a pre-determined condition is satisfied.

10. An electronic device, comprising a processor and a memory, the memory storing one or more computer program instructions, wherein the one or more computer program instructions are stored in the memory, and upon being executed by the processor, implement a data processing method, and the method comprises:
receiving a task allocated to each processing core of the plurality of processing cores from a management workstation;
separately executing the task allocated to each processing core by each processing core of the plurality of processing cores, and generating a task result with a pre-determined data structure after each execution of a task;
merging the task result generated by each processing core after each execution into a shared task result stored in an internal memory of the execution workstation, the shared task result and the task result generated by each processing core after each execution having a same data structure; and
when a pre-determined condition is satisfied, using the shared task result for conducting reduction with a task result of another execution workstation.

11. A computer-readable storage medium, non-temporarily storing computer-readable instructions, wherein the computer-readable instructions, upon being executed by a processor, implement steps of the data processing method of claim 1.

12. The execution workstation of claim 9, wherein the pre-determined condition is that the shared task result has been merged with a pre-determined number of task results.

13. The execution workstation of claim 9, wherein the pre-determined condition is receiving an instruction from the management workstation.

14. The electronic device of claim 10, wherein the pre-determined condition is that the shared task result has been merged with a pre-determined number of task results.

15. The electronic device of claim 10, wherein the pre-determined condition is receiving an instruction from the management workstation.

16. The electronic device of claim 10, wherein the method further comprises sending a state of each task being completed to the management workstation; and
the instruction is an instruction issued by the management workstation to determine that tasks of a current task group have been completed according to the state of each task.

17. The electronic device of claim 10, wherein the merging the task result generated by each processing core after each execution into a shared task result stored in an internal memory of the execution workstation comprises:
generating a shared task result with the pre-determined data structure and an initial value of 0 in the internal memory; and
after a processing core completes a task and generates a task result, merging the task result with a shared task result stored currently to obtain a merged result, and using the merged result to update the shared task result.

18. The electronic device of claim 10, wherein the merging the task result generated by each processing core after each execution into a shared task result stored in an internal memory of the execution workstation comprises:
storing a task result first generated when the plurality of processing cores processes a task of a current task group as an initial shared task result; and
after a processing core completes a task and generates a task result, merging the task result with a shared task result stored currently to obtain a merged result, and using the merged result to update the shared task result.

19. The electronic device of claim 10, wherein the using the shared task result for conducting reduction with a task result of another execution workstation comprises:
serializing the shared task result to obtain a serialized shared task and sending the serialized shared task result to the another execution workstation or the management workstation; or
receiving a task result from the another execution workstation and performing reduction on the task result and the shared task result.

20. The electronic device of claim 10, further comprising:
when the pre-determined condition is satisfied, storing the shared task result into a non-volatile storage apparatus.
